(19) United States
(12) Patent Application Publication
(10) Pub. No.: US 2014/0095244 A1
(43) Pub. Date: Apr. 3, 2014

(54) FACILITY VISUALIZATION AND MONITORING

(71) Applicant: Computer Sciences Corporation, Falls Church, VA (US)

(72) Inventors: Jeff Sagraves, Matthews, NC (US); Les Bethel, Matthews, NC (US); Renzo Ramos, Matthews, NC (US); Phil Grove, Matthews, NC (US)

(73) Assignee: Computer Sciences Corporation, Falls Church, VA (US)

(21) Appl. No.: 14/043,545

(22) Filed: Oct. 1, 2013

Related U.S. Application Data
(60) Provisional application No. 61/708,781, filed on Oct. 2, 2012.

(51) Int. Cl. G06Q 10/08

(52) U.S. Cl. CPC G06Q 10/087
USPC 705/7.24; 705/28

(57) ABSTRACT

A method includes generating, using a three-dimensional model file corresponding to a facility location, a graphical user interface depicting a virtual representation of the facility location from a first point of view, one or more of a plurality of assets located at the facility location being visible from the first point of view. The method further includes receiving navigation instructions indicating a desire of a user to move within the virtual representation to a second point of view, and updating the graphical user interface to depict a virtual representation of the facility location from the second point of view, a particular asset being visible from the second point of view. The method further includes receiving a user selection of the particular asset, accessing asset information associated with the particular asset, and displaying at least a portion of the accessed asset information.

### RELATED APPLICATION

This application claims the benefit under 35 U.S.C. §119(e) of U.S. Provisional Application Ser. No. 61/708,781 filed Oct. 2, 2012.

### TECHNICAL FIELD OF THE INVENTION

This disclosure relates generally to operations management and more particularly to facility visualization and monitoring.

### BACKGROUND OF THE INVENTION

Operations management generally relates to the field of designing and controlling the process of production of goods and/or services for an enterprise—i.e., the process of converting inputs (in the form of materials, labor, and/or energy) into outputs (in the form of goods and/or services). Often, operations managers are tasked with the responsibility of ensuring efficient operation of enterprise assets (e.g., machinery or other equipment) such that those assets efficiently use resources and effectively meet customer requirements. To perform this function, it may be necessary for operations managers to rely on asset information generated and maintained by one or more other divisions within an enterprise. As the amount and types of data maintained has increased, so too has the complexity of effectively relying on that data for purposes of operations management.

### OVERVIEW

According to embodiments of the present disclosure, disadvantages and problems associated with previous systems may be reduced or eliminated.

In certain embodiments, a method includes generating, using a three-dimensional model file corresponding to a facility location, a graphical user interface depicting a virtual representation of the facility location from a first point of view, one or more of a plurality of assets located at the facility location being visible from the first point of view. The method further includes receiving navigation instructions indicating a desire of a user to move within the virtual representation to a second point of view, and updating the graphical user interface to depict a virtual representation of the facility location from the second point of view, a particular asset being visible from the second point of view. The method further includes receiving a user selection of the particular asset, accessing asset information associated with the particular asset, and displaying at least a portion of the accessed asset information.

Certain embodiments of the present disclosure may provide one or more technical advantages. For example, certain embodiments of the present disclosure may provide a user-friendly interface by which a user may view enterprise assets along with asset information associated with those assets. Additionally, because the asset information may be accessed from a separately-maintained Enterprise Resource Planning (ERP) system for the enterprise, certain embodiments of the present disclosure may allow existing asset information to be leveraged such that it may be consumed in a more user-friendly manner.

Certain embodiments of the present disclosure may include some, all, or none of the above advantages. One or more other technical advantages may be readily apparent to those skilled in the art from the figures, descriptions, and claims included herein.

### BRIEF DESCRIPTION OF THE DRAWINGS

FIG. 1 illustrates an example system for providing facility visualization and monitoring, according to certain embodiments of the present disclosure;

FIG. 2 illustrates and example 3-D model file rendered on a graphical user interface (GUI) such that the user may navigate a virtual, 3-D representation of a particular facility location, according to certain embodiments of the present disclosure; and

FIG. 3 illustrates an example method for providing facility visualization and monitoring, according to certain embodiments of the present disclosure.

### DETAILED DESCRIPTION OF THE INVENTION

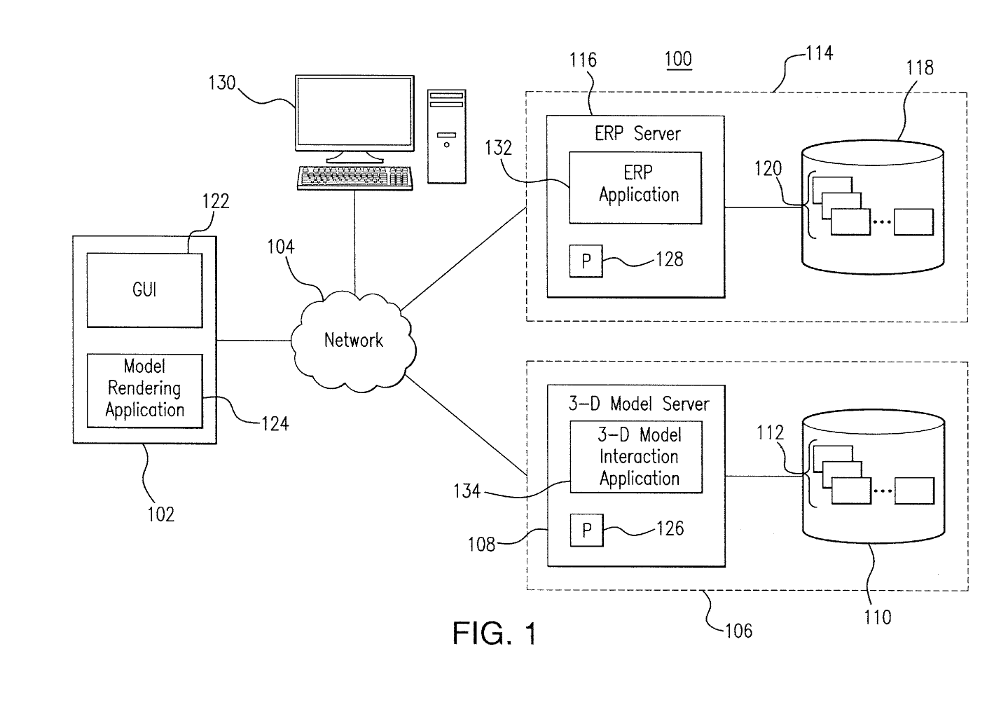

FIG. 1 illustrates an example system 100 for providing facility visualization and monitoring, according to certain embodiments of the present disclosure. System 300 may include one or more user systems 102 each configured to communicate, via a network 104, with a facility model system 106. Facility model system 106 may include a facility model server 108 arid a facility model database 110. Facility model database 110 may store one or more 3-D mode files 112 each associated with a facility location within an enterprise. Each 3-D model file 112 may be used by a user system 102 to render a 3-D model of the corresponding facility location such that the user of the user system 102 may virtually navigate the facility location in order to view the one or more assets within the facility location. System 100 may additionally include an Enterprise Resource Planning (ERP) system 114 including an ERP server 136 and an ERP database 118. ERP database 118 may store asset information 120 associated with the one or more assets located in each facility location within the enterprise. Facility model server 108 may facilitate interaction with ERP system 134 such that asset information 120 may be displayed along with a corresponding asset in the 3-D rendering of a facility location displayed to a user of a user system 102. Although this particular implementation of system 100 is illustrated and primarily described, the present invention contemplates any suitable implementation of system 100 according to particular needs.

In general, system 100 is operable to allow an enterprise employee (i.e., a user of a user system 102) to navigate virtual, 3-D models of facility locations within the enterprise. Within a 3-D model of a facility location, the employee may view particular assets located at the facility location (e.g., pieces of machinery or other equipment) as well as asset information 120 associated with those assets (e.g., maintenance schedules, work order schedules, notifications, PMs, overdue PMs, outages, costing information, or any other suitable information). Because the asset information 120 may be accessed from a separately-maintained ERP system 114 for the enterprise, certain embodiments of the present disclosure may allow existing asset information 120 to be leveraged such that it may be consumed in a more user-friendly manner.

The one or more user systems 102 (which, for simplicity, are referred to primarily in the singular throughout the remainder of this description) may include one or more computer systems at one or more locations. Each computer system may include any appropriate input devices (such as a keypad, touch screen, mouse, or other device that can accept information), output devices, mass storage media, or other suitable components for receiving, processing, storing, and communicating data. Both the input device and output device may include fixed or removable storage media such as a magnetic computer disk, CD-ROM, or other suitable media to both receive input from and provide output to a user of user system 102. Each computer system may include a personal computer, workstation, network computer, kiosk, wireless data port, personal data assistant (PDA), tablet computer, smart phone, one or more processors within these or other devices, or any other suitable processing device. In short, user system 102 may include any suitable combination of software, firmware, and hardware.

In certain embodiments, user system 102 may include a graphical user interface (GUI) 122 that allows a user to interact with user system 102 and/or other components of system 100. GUI 122 may be delivered using an online portal, hypertext mark-up language (HTML) pages for display and data capture, or in any other suitable manner. For example, GUI 122 may allow user system 102 to interact with components of facility model system 106 (e.g., 3-D model interface application 134, described in more detail below) such that a 3-D model file 112 may be displayed to a user via GUI 122. In certain embodiments, user system 102 may additionally include a locally-stored model rendering application 124 that facilitates interpretation and/or rendering of 3-D model files 112.

User system 102 may be communicatively coupled to one or more other components of system 100 (e.g., facility model system 106 and/or ERP system 114) via network 104. Network 104 may facilitate wireless or wireline communication and may communicate, for example, IP packets, Frame Relay frames, Asynchronous Transfer Mode (ATM) cells, voice, video, data, and other suitable information between network addresses. Network 104 may include one or more local area networks (LANs), radio access networks (RANs), metropolitan area networks (MANs), wide area networks (WANs), all or a portion of the global computer network known as the Internet, and/or any other communication system or systems at one or more locations.

Facility model system 106 may include any suitable system operable to facilitate (1) rendering of 3-D model tiles 112 at user systems 102, and/or (2) interfacing with ERP system 114 such that asset information 120 may be displayed along with assets depicted in rendered 3-D model files 112 (as discussed in further detail below). In certain embodiments, facility model system 106 may include a facility model server 108. Facility model server 108 may include one or more electronic computing devices operable to receive, transmit, process, and store data associated with system 100. For example, facility model server 108 may include one or more general-purpose PCs, Macintoshes, workstations, Unix-based computers, server computers, one or more server pools, or any other suitable devices. Facility model server 108 may include one or more processing modules 126, each of which may include one or more microprocessors, controllers, or any other suitable computing devices or resources. Processing modules 126 may work, either alone or with other components of system 100, to provide a portion or all of the functionality of system 100 described herein. In short, facility model server 108 may include any suitable combination of software, firmware, and hardware. Although a single facility model server 108 is illustrated, the present disclosure contemplates system 100 including any suitable number of facility model servers 108. Moreover, although referred to as a “server,” the present disclosure contemplates facility model server 108 comprising any suitable type of processing device or devices.

Facility model server 108 may additionally include (or are communicatively coupled to) a facility model database 110. Facility model database 110 may comprise any suitable memory module and may take the form of volatile or non-volatile memory, including, without limitation, magnetic media, optical media, Random Access Memory (RAM), Read-only Memory (ROM), removable media, or any other suitable local or remote memory component.

In certain embodiments, facility model database 110 may store one or more 3-D model files 112. Each 3-D model file 112 may correspond to all or a portion of a facility location within an enterprise. For example, a particular 3-D model file 112 may correspond to a particular facility location (e.g., a warehouse), and, when rendered (e.g., via GUI 122 of user system 102), the particular 3-D model 112 may depict a 3-D virtual representation of the facility that includes one or more assets (e.g., mills, routers, presses, plastic or metal forming systems, packaging systems, labeling systems, ovens, printers, inspection systems, conveyors, forklifts, or any other suitable machinery/equipment from any of a wide range of industries) located at the facility.

In certain embodiments, 3-D model files 112 may be generated using one or more computer graphics software programs, such as those used to create video games. As particular examples, 3-D model files 112 may be generated using one or more of Autodesk® Maya® 3-D animation software offered by Autodesk, Inc., the Unity game engine offered by Unity Technologies, or any other suitable software program.

ERP system 114 may include any suitable system operable to facilitate entry and storage of asset information 120 (as described in further detail below). In certain embodiments, ERP system 114 may include an ERP server 116. ERP server 116 may include one or more electronic computing devices operable to receive, transmit, process, and store data associated with system 100. For example, ERP server 116 may include one or more general-purpose PCs, Macintoshes, workstations, Unix-based computers, server computers, one or more server pools, or any other suitable devices. ERP server 116 may include one or snore processing modules 128, each of which may include one or more microprocessors, controllers, or any other suitable computing devices or resources. Processing modules 128 may work, either alone or with other components of system 100, to provide a portion or all of the functionality of system 100 described herein. In short, ERP server 116 may include any suitable combination of software, firmware, and hardware. Although a single ERP server 116 is illustrated, the present disclosure contemplates system 100 including any suitable number of ERP servers 116. Moreover, although referred to as a “server,” the present disclosure contemplates facility ERP server 116 comprising any suitable type of processing device or devices.

ERP server 116 may additionally include (or be communicatively coupled to) an ERP database 118. ERP database 118 may comprise any suitable memory module and may take the form of volatile or non-volatile memory, including, without limitation, magnetic media, optical media, RAM, ROM, removable media, or any other suitable local or remote memory component.

In certain embodiments, ERP database 118 may store asset information 120, Asset information 120 may include any suitable information concerning an asset within an enterprise. For example, assets may include pieces of equipment owned/operated by an enterprise, and asset information 120 may include information concerning the maintenance and/or operation of a particular piece of that equipment (e.g., maintenance schedules, work order schedules, notifications, PMs, overdue PMs, outages, costing information, or any other suitable information).

In certain embodiments, ERP system 114 may be communicatively coupled (e.g., via network 104) to one or more ERP user systems 130 (which, for simplicity, are referred to primarily in the singular throughout the remainder of this description) that facilitate the creation/storage of asset information 120. ERP user system 130 may include one or more computer systems at one or more locations. Each computer system may include any appropriate input devices (such as a keypad, touch screen, mouse, or other device that can accept information), output devices, mass storage media, or other suitable components for receiving, processing, storing, and communicating data. Both the input device and output device may include fixed or removable storage media such as a magnetic computer disk, CD-ROM, or other suitable media to both receive Input from and provide output to a user of user system 102. Each computer system may include a personal computer, workstation, network computer, kiosk, wireless data port, personal data assistant (PDA), tablet computer, one or more processors within these or other devices, or any other suitable processing device. In short, user system 102 may include any suitable combination of software, firmware, and hardware.

For example, ERP user systems 130 may access (e.g., via network 104) an ERP application 132 running on ERP server 116. ERP application 132 may facilitate the creation/storage of asset information 120 by a user of ERP user systems 130. For example, ERP application 132 may include any commercially available resource planning or asset management application, such as those offered by SAP AG, Oracle, IBM (e.g., Maximo), and Ariba, Inc.

In certain embodiments, ERP system 114 and ERP user systems 130 may be utilized within an enterprise independent of facility model system 106. For example, ERP system 114 and ERP user systems 130 may be used by an accounting department within an enterprise to maintain asset information 120 for tax purposes. The asset information 120 maintained by the accounting department, however, may additionally be relevant to users of facility model system 106 (e.g., users of user system 102, such as operations managers). Although ERP system 114 and ERP user systems 130 have been described as being used by a particular department within an enterprise for a particular purpose, the present disclosure contemplates ERP system 114 and ERP user systems 130 being used by any suitable department(s) within an enterprise for any suitable purpose.

In addition to being useful within ERP system 154 (e.g., for tax purposes, as described above), the asset information 120 maintained in ERP system 114 may be useful to other departments within an enterprise. For example, a user of user system 102 (e.g., an operations manager) may be charged with monitoring the operation and/or maintenance of enterprise assets, and the asset information 120 maintained in ERP system 114 may be useful in performing this function. Accordingly, the above-described 3-D model server 108 may include a 3-D model interface application 134 that accesses asset information 120 from ERP system 114 such that the asset information 120 may be displayed along with a corresponding asset in a 3-D virtual representation of facility housing the asset rendered on GUI 122 (as described above).

For example, 3-D model interface application 134 may include application programming interfaces (APIs) that allow for communication with ERP application 132 such that asset information 120 for assets included in a 3-D model tile 112 may be displayed to a user of user system 102. As one particular example, in embodiments in which ERP application 132 is a commercially available software package offered by SAP AG, 3-D model interface application 134 may utilize an API using Web Service Description Language (WSDL) for communication with ERP application 132. Moreover, the above-described 3-D model files 132 may identify assets using the same asset identifier used in ERP system 114 such that the correct information 120 may be accessed and displayed at the time the 3-D model files 112 are rendered.

In certain embodiments, 3-D model interface application 134 may access asset information 120 for a particular asset in response to a user selection of that asset. For example, a user of user system 102 may select a 3-D model file 112 corresponding to a particular facility location, and the selected 3-D model file 112 may be rendered on GUI 122 such that the user may navigate a virtual, 3-D representation of the particular facility location. One or more assets located at the particular facility location may be included in the virtual, 3-D representation such that the user may select a particular asset. In response to a user selection of a particular asset within the virtual, 3-D representation of the particular facility location, 3-D model interface application 134 may access asset information 120 corresponding to the particular asset from ERP system 114 (e.g., using a device identifier that is used in both the 3-D model file 112 and ERP system 114), The accessed asset information 120 may then be returned to user system 102 such that it may be displayed to the user within the virtual, 3-D representation of the particular facility location (e.g., using a pop up window).

In certain embodiments, the user may additionally specify a particular type of asset information 120 for the particular asset (e.g., using a drop down menu associated with the particular asset), and 3-D model interlace application 134 may access and return only the requested type of asset information 120.

In certain embodiments, the first time asset information 120 for a particular asset is requested, it is accessed ERP system 114 and stored in a cache local to user system 102 and/or facility model system 106. Accordingly, subsequent requests for asset information 120 for the particular asset may be fulfilled using the cached asset information 120 In lieu of accessing the asset information in ERP system 114.

In certain embodiments, a portion of the asset information 120 for an asset may be automatically displayed (i.e., displayed without user selection of the asset) along with the asset within a virtual, 3-D representation of a facility location. The portion of the asset information 120 that may be automatically displayed is referred to herein as status information and may include, for example, an operational efficiency associated with the asset. Displaying status information associated with each of the assets depicted in the virtual, 3-D representation of the facility location displayed to the user may help inform the user as to which assets are in need of attention (i.e., those assets for which the user should view a more complete set of asset information 120).

Certain embodiments of the present disclosure may provide one or more technical advantages. For example, because the asset information 120 may be accessed from a separately-maintained ERP system 114 for the enterprise, certain embodiments of the present disclosure may allow existing asset information 120 to be leveraged such that it may be consumed in a more user-friendly manner.

Although a particular implementation of system 100 is illustrated and primarily described, the present disclosure contemplates any suitable implementation of system 100 according to particular needs. Although a particular number of components of system 100 have been illustrated and primarily described above, the present invention contemplates system 100 including any suitable number of such components. Furthermore, the various components of system 100 described above may be local or remote from one another. Additionally, the components of system 100 may be implemented in any suitable combination of hardware, firmware, and software.

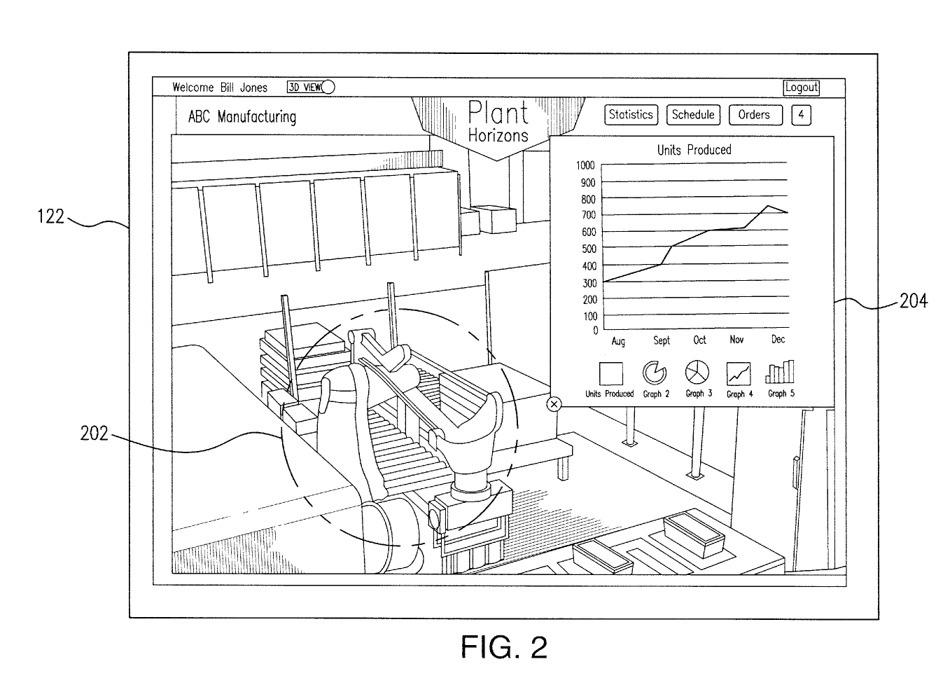

FIG. 2 illustrates and example 3-D model file 112 rendered on GUI 122 such that the user may navigate a virtual, 3-D representation of a particular facility location, according to certain embodiments of the present disclosure. From the depicted point of view within the virtual, 3-D representation of the particular facility location, an asset 202 located at the particular facility location may be visible. As described above, a user viewing the virtual, 3-D representation of the particular facility location may select asset 202 such that the user may view an asset Information display 204 associated with asset 202. In particular, 3-D model interface application 134 may access asset information 120 corresponding to the asset 202 from ERP system 114, and the accessed asset information 120 may then be returned to user system 102 such that it may be displayed to the user as asset information display 204. In the illustrated example, a graphical representation of the number of units produced by asset 202 is displayed as asset information display 204. Although a particular asset information display 204 associated with a particular asset 204 is depicted and described, the present disclosure contemplates any suitable asset information display 204 associated with any suitable asset 204, according to particular needs.

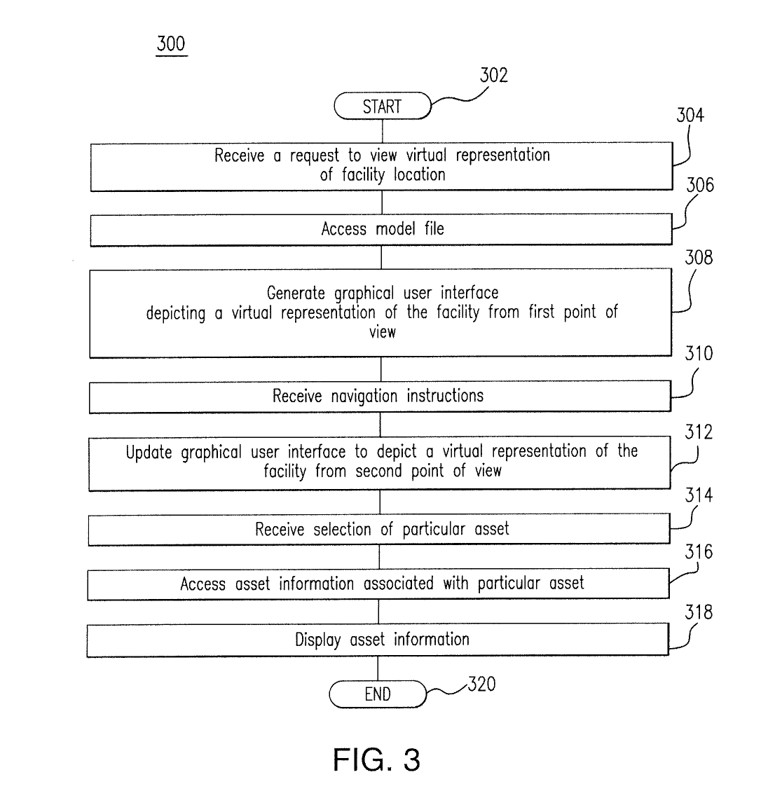

FIG. 3 illustrates an example method 300 for providing facility visualization and monitoring, according to certain embodiments of the present disclosure. The method begins at step 302. At step 304, a request is received (e.g., at 3-D model application 134 of facility model system 102) from a user requesting to view a virtual representation of a facility location. At step 306, 3-D model interface application 134 accesses a three-dimensional model file 312 corresponding to the facility location. The accessed 3-D model file 112 may be used by either 3-D model application 134 or model rendering application 124 (or a combination of the two) to generate, using GUI 122, a 3-D, virtual representation of the facility location.

In particular, at step 308, the three-dimensional model file 112 is used to generate a graphical user interface depicting a virtual representation of the facility location from a first point of view, one or more of a plurality of assets located at the facility location being visible from the first point of view. At step 310, navigation instructions indicating a desire of the user to move within the virtual representation of the facility location from the first point of view to a second point of view are received. At step 312, the graphical user interface is updated to depict a virtual representation of the facility location from the second point of view, a particular asset of the plurality of assets located at the facility location being visible from the second point of view.

At step 314, 3-D model interface application 134 receives a user selection of the particular asset. In certain embodiments, the user selection of the particular asset may include an asset identifier associated with the particular asset such that asset information 120 associated with the particular asset may be accessed from ERP system 314 (as the asset identifier used in 3-D model file 112 may he the same as that used in ERP system 114). At step 316, 3-D model interface application 334 accesses asset information 320 associated with the particular asset, and, at step 318, at least a portion of the accessed asset information 120 associated with the particular asset is displayed to the user.

When the user no longer needs to navigate within the virtual representation of the facility location and/or view asset information 120 associated with assets located at the facility location, the method then ends at step 320.

Although the steps of method 300 have been described as being performed in a particular order, the present disclosure contemplates that the steps of method 300 may be performed in any suitable order, according to particular needs.

Although the present disclosure has been described with several embodiments, diverse changes, substitutions, variations, alterations, and modifications may be suggested to one skilled in the art, and it is intended that the invention encompass all such changes, substitutions, variations, alterations, and modifications as fall within the spirit and scope of the appended claims.

What is claimed is:

1. A method, comprising:
generating, using a three-dimensional model file corresponding to a facility location, a graphical user interface depicting a virtual representation of the facility location from a first point of view, one or more of a plurality of assets located at the facility location being depicted within the virtual representation of the facility location from the first point of view;
receiving navigation instructions indicating a desire of a user to move within the virtual representation of the facility location from the first point of view to a second point of view;
updating the graphical user interface to depict a virtual representation of the facility location from the second point of view, a particular asset of the plurality of assets located at the facility location being depicted within the virtual representation of the facility location from the second point of view;
receiving a user selection of the particular asset;
accessing asset information associated with the particular asset; and
displaying at least a portion of the accessed asset information associated with the particular asset.

2. The method of claim 1, wherein:
the particular asset comprises a piece of factory equipment; and
the displayed asset information comprises a work order schedule for the piece of factory equipment.

3. The method of claim 1, wherein:
the particular asset comprises a piece of factory equipment; and
the displayed asset information comprises a maintenance schedule for the piece of factory equipment.

4. The method of claim 1, wherein the asset information associated with the particular asset is accessed using an asset identifier assigned to the particular asset in the three-dimensional model file.

5. The method of claim 1, wherein:
the asset information associated with the particular asset is stored in a first one or more memory modules, the first one or more memory modules being associated with an Enterprise Resource Planning (ERP) system for an enterprise; and
the three-dimensional model file corresponding to the facility location is stored in a second one or more memory modules, the second one or more memory modules being associated with a facility model system for the enterprise.

6. The method of claim 5, wherein the ERP system is maintained independently of the facility model system.

7. The method of claim 1, wherein:
the received user selection of the particular asset specifies a particular type of asset information; and
the displayed portion of the asset information associated with the particular asset corresponds to the particular type of asset information specified.

8. A system, comprising:
one or more memory modules operable to store:
asset information associated with a plurality of assets located at a facility location; and
a three-dimensional model file corresponding to the facility location;
one or more processing modules configured to execute instructions to cause the system to perform operations comprising:
generating, using the three-dimensional model file, a graphical user interface depicting a virtual representation of the facility location from a first point of view, one or more of the plurality of assets being depicted within the virtual representation of the facility location from the first point of view;
receiving navigation instructions indicating a desire of a user to move within the virtual representation of the facility location from the first point of view to a second point of view;
updating the graphical user interface to depict a virtual representation of the facility location from the second point of view, a particular asset of the plurality of assets being depicted within the virtual representation of the facility location from the second point of view;
receiving a user selection of the particular asset; and
displaying at least a portion of the asset information associated with the particular asset.

9. The system of claim 8, wherein:
the particular asset comprises a piece of factory equipment; and
the displayed asset information comprises a work order schedule for the piece of factory equipment.

10. The system of claim 8, wherein:
the particular asset comprises a piece of factory equipment; and
the displayed asset information comprises a maintenance schedule for the piece of factory equipment.

11. The system of claim 8, wherein the displayed asset information associated with the particular asset is accessed from the one or more memory modules using an asset identifier assigned to the particular asset in the three-dimensional model file.

12. The system of claim 8, wherein the one or more memory modules comprise:
a first one or more memory modules operable to store the asset information associated with the plurality of assets located at the facility location, the first one or more memory modules being associated with an Enterprise Resource Planning (ERP) system for an enterprise; and
a second one or more memory modules operable to store the three-dimensional model file corresponding to the facility location, the second one or more memory modules being associated with a facility model system for the enterprise.

13. The system of claim 12, wherein the ERP system is maintained independently of the facility model system.

14. The system of claim 8, wherein:
the user selection of the particular asset specifies a particular type of asset information; and
the displayed portion of the asset information associated with the particular asset corresponds to the particular type of asset information specified.

15. A non-transitory computer-readable medium encoded with logic, the logic operable when executed to:
generate, using a three-dimensional model file corresponding to a facility location, a graphical user interface depicting a virtual representation of the facility location from a first point of view, one or more of a plurality of assets located at the facility location being depicted within the virtual representation of the facility location from the first point of view;
receive navigation instructions indicating a desire of a user to move within the virtual representation of the facility location from the first point of view to a second point of view;
update the graphical user interface to depict a virtual representation of the facility location from the second point of view, a particular asset of the plurality of assets located at the facility location being depicted within the virtual representation of the facility location from the second point of view;
receive a user selection of the particular asset;
access asset information associated with the particular asset; and
display at least a portion of the accessed asset information associated with the particular asset.

16. The computer-readable medium of claim 15, wherein:
the particular asset comprises a piece of factory equipment; and
the displayed asset information comprises a work order schedule for the piece of factory equipment.

17. The computer-readable medium of claim 15, wherein:
the particular asset comprises a piece of factory equipment; and
the displayed asset information comprises a maintenance schedule for the piece of factory equipment.

18. The computer-readable medium of claim 15, wherein the asset information associated with the particular asset is accessed using an asset identifier assigned to the particular asset in the three-dimensional model file.

19. The computer-readable medium of claim 15, wherein:
the asset information associated with the particular asset is stored in a first one or more memory modules, the first one or more memory modules being associated with an Enterprise Resource Planning (ERP) system for an enterprise; and
the three-dimensional model file corresponding to the facility location is stored in a second one or more memory modules, the second one or more memory modules being associated with a facility model system for the enterprise.

20. The computer-readable medium of claim 19, wherein the ERP system is maintained independently of the facility model system.

21. The computer-readable medium of claim 15, wherein:
the received user selection of the particular asset specifies a particular type of asset information; and
the displayed portion of the asset information associated with the particular asset corresponds to the particular type of asset information specified.
